(19) United States
(12) Patent Application Publication
(10) Pub. No.: US 2023/0296393 A1
(43) Pub. Date: Sep. 21, 2023

(54) PARKING ASSISTANCE METHOD FOR A DRIVE WITH A MOTOR VEHICLE, PARKING ASSISTANCE DEVICE, STORAGE MEDIUM, MOBILE PORTABLE TERMINAL, SERVER DEVICE AND MOTOR VEHICLE

(71) Applicant: CARIAD SE, Wolfsburg (DE)

(72) Inventors: Franziska RIEGERT, München (DE); Franz MIRLACH, Lenting (DE); Bastian HINTERLEITNER, Neuburg (DE); Ingo TOTZKE, Ingolstadt (DE)

(73) Assignee: CARIAD SE, Wolfsburg (DE)

(21) Appl. No.: 18/184,935

(22) Filed: Mar. 16, 2023

(30) Foreign Application Priority Data
Mar. 16, 2022 (DE) 102022106127.2

(51) Int. Cl. G01C 21/34; G08G 1/14

(52) U.S. Cl. CPC G01C 21/3476; G08G 1/141

(57) ABSTRACT

Disclosed is a parking assistance method for a drive with a motor vehicle. A parking assistance device determines a navigation destination of the drive of the motor vehicle, receives occupancy state data from at least one data source external to the motor vehicle of an availability of free parking spaces at the navigation destination and ascertains at least one location of a free parking space based on the received occupancy state data. The parking assistance device examines whether the navigation destination satisfies a preset criterion, including a minimum probability of a driver-specific favoring and/or frequency, and predetermines an information content for parking space data for the drive depending on whether the navigation destination satisfies the preset favoring criterion. The parking assistance device provides parking space data with the predetermined information content and transfers the provided parking space data to an output device.

### CROSS REFERENCE TO RELATED APPLICATION

This application claims priority benefit from German Patent Application No. 102022106127.2 filed on Mar. 16, 2022, the contents of which are incorporated herein by reference.

### BACKGROUND

Aspects of invention relate to a parking assistance method for a drive with a motor vehicle. In addition, aspects of the invention relate to a parking assistance device, to a storage medium with a program code, to a mobile, portable terminal, to a server device for operating in the Internet and to a motor vehicle.

All types of proactive notifications of parking assistants during the drive should possibly be helpful and unintrusive. Commuters, who regularly drive to the same locations with the car every day, need different information about the availability of parking spaces at different times. Regular destinations of a driver, including the route which the driver takes there, are collected and predicted. Information about the availability of parking spaces (on the road and off the road) exists, but are still too inaccurate at present to completely rely thereon, especially on the road.

Real-time availability data for parking spaces on and off the road is present up to now. A display of parking information for example two kilometers before each destination is possible up to now, and there are several apps or in-car systems with manual search function for parking spaces on and off the road (including current occupancy, prices, opening times).

DE 10 2011 003 772 A1 relates to a method and to a device for assisting a driver for finding a parking possibility for a vehicle as well as to a corresponding computer program product.

From DE 10 2014 214 758 A1, a method for a navigation system of a vehicle is known, which is in particular suitable for automated selection of a parking space within the scope of route planning.

From WO 2015/144396 A1, an approach for identifying and coordinating for parking spaces for a group of motor vehicles is known, which travel to a same travel destination.

On each drive, recommendations appear regardless of whether the driver really needs the information or whether there are parking spaces at all in the vicinity. Proactive parking space recommendations are only helpful if the driver really needs assistance and if the displayed information is correct. Unnecessary or even false recommendations are annoying to the driver and even could distract him. In other applications, there are possibly no recommendations at all and the driver has to manually search, which can be distracting and demanding.

Up to now, the driver on his daily drives can only ignore or wipe away unwanted pop-ups of the parking assistant. Also, the driver can manually use the parking information system during the drive or not at all.

### SUMMARY

An aspect underlying the invention is improving an assistance of a driver in the parking space search.

Disclosed is a parking assistance method and devices according to the invention.

An example of the first examines occupancy state data, which describes information about an availability of free parking spaces for a preset perimeter around a navigation destination, based on whether the navigation destination of the motor vehicle is a navigation destination known to the current driver or a navigation destination foreign (or unknown) to the current driver. Depending thereon, the information content of the occupancy state data is adapted to parking space data. In other words, an amount of data (thus a display volume of data) and/or a data content for the display can be adapted. The parking space data is that data which describes a proposal to the ascertained location of the free parking space related to the navigation destination. In other words, the occupancy state data is for example data from other motor vehicles, which describes for example a free parking space and the location thereof at the navigation destination, while the parking space data is that data, which describes the content to be output and a manner of the output of the information (for example “a single free parking space at Müller street 27” or “Today, the Müller street is almost completely occupied, better try parking space search in the Backer street”). In other words, depending whether or not the driver presumably is well versed in the navigation system, the amount of data and the manner of the proposal for the parking space search are adapted. Thus, the content and/or the amount of the information of the parking space data are modulated or adapted depending on a local knowledge of the driver.

The utility of parking notifications depends on the data coverage in the region, the availability of free parking spaces, the data quality and the experience and the knowledge of the driver. Every day, commuters need different parking information at different times. The information can be less obtrusively presented if the driver already very well knows his drive destination. It is allowed to present an individual middle course between too much and no information. The information content and the timing of a pop-up can be adapted to the respective situation. Thereby, less distraction and, thus, increased driving safety also arises. An increased acceptance of the users and increased comfort also arise since the proposed system results in less unnecessary and unhelpful notifications. The optimized parking search results in less traffic in cities and less infringement by parking violation.

In other words, the display volume and the display content are variable.

The parking assistance method according to aspects of the invention for a drive with a motor vehicle is performed by a parking assistance device. A parking assistance device includes an apparatus, an apparatus component and/or an apparatus group, which is configured for receiving signals, evaluating signals, as well as generating and sending signals. In particular, the parking assistance device is configured to communicate with servers external to motor vehicle and/or with other motor vehicles for example via wireless data communication, as well as to receive and evaluate location data. For example, the parking assistance device can be configured as a control chip, computer program, computer or parking assistance system.

The parking assistance device determines a navigation destination of the drive of the motor vehicle. In particular, this can be effected during the drive of the motor vehicle. Upon determination of the navigation destination, the parking assistance device can communicate with a navigation device or a navigation system can be integrated in the parking assistance device.

The parking assistance device receives occupancy state data from at least one data source external to motor vehicle with respect to the motor vehicle, for which the parking assistance device performs the parking assistance method. The motor vehicle, for which the parking assistance device performs the parking assistance method, can also be referred to as “target motor vehicle”. A data source external to motor vehicle can for example be another motor vehicle or a data server external to motor vehicle. Ideally, the parking assistance device can receive occupancy state data from a plurality of data sources external to motor vehicle.

Therein, the received occupancy state data describes information to an availability of free parking spaces for a preset perimeter around the navigation system. For example, the perimeter can be preset by default as a distance to the navigation destination or for example for a corresponding urban district. For example, the occupancy state data can describe the report of a free parking space at a certain location. For example, the occupancy state data can also comprise a timestamp, which indicates the time, in which for example sensors of the other motor vehicles have captured the free parking space.

Based on the received occupancy state data, the parking assistance device ascertains at least one location of a free parking space.

The parking assistance device examines if the navigation destination satisfies a preset favoring criterion, wherein the preset favoring criterion presets a minimum probability of a driver-specific favoring and/or the frequency, with which the driver of the motor vehicle drives to this navigation destination. For example based on a history in a user profile of the driver, the parking assistance device can read if the driver has already many times driven to this navigation destination. Additionally or alternatively, the parking assistance device can for example examine in a database of the navigation system if the navigation destination is stored as a favorite.

Depending on whether the navigation destination satisfies the preset favoring criterion, the parking assistance device predetermines an information content for parking space data for the drive. The parking space data is that data, which describes a proposal to the ascertained location of the free parking space related to the navigation destination. In contrast to the occupancy state data, the parking space data thus indicates the proposal and thereby the output of the parking space proposal for example by a screen of the vehicle. In examining if the navigation destination satisfies the preset favoring criterion, the parking assistance device can for example distinguish between a worksite of the driver and a new, unknown travel destination. The parking space data, which the parking assistance device provides thereupon depending on the occupancy state data, then has the predetermined information content. Therein, the information content can relate to an amount of data and/or to a data content.

In other words, the parking space data provided by the parking assistance device has a fixed amount of data and/or a fixed data content to the location of the free parking space according to the predetermined information content. In other words, the parking space data, which describes that information, which is output to the driver for example via a screen, can be very general information, for example brief information to the general occupancy state if the navigation destination is for example the worksite of the driver; or, if the navigation destination is a new travel destination, where the driver was not yet, the parking space data can for example include a very detailed indication to the location of the free parking space and for example a route description. The case also comes within, that, if the navigation destination is a location, at which the driver is every day, the free parking space is not proposed at all, but only the street, in which the free parking space is located.

The parking assistance device transfers the provided parking space data to an output device, in particular an output device of the motor vehicle for outputting the provided parking space data. Therein, an output device is an apparatus, an apparatus component or an apparatus group, which is arranged and configured to output image and/or audio data. For example, the output device can be a display device with a screen.

The above described advantages arise.

In an example embodiment of the parking assistance method according to the invention, the predetermined information content can preset a data content and/or an amount of data, thus a display volume, of the parking space data. Corresponding to the local knowledge of the driver, thus, the driver is assisted at best if he is at an unknown navigation destination, but is not unnecessarily distracted if he searches a parking space at a navigation destination, with which he is very familiar. Thus, the parking assistance device can allow a particularly good middle course between information and reduction of distraction.

These advantages are even further enhanced by an embodiment of the parking assistance method according to the invention, in which the parking assistance device, if the navigation destination satisfies the preset favoring criterion, sets an amount of data in a first preset range of values as the information content; and/or if the navigation destination does not satisfy the preset favoring criterion: sets an amount of data in a second preset range of values as the amount of data. Therein, the second preset range of values sets a higher amount of data compared to the first preset range of values. In addition, the amount of data can be continuously adapted to a probability that the favoring criterion is satisfied.

In a development, if the navigation destination satisfies the preset favoring criterion, the parking assistance device can examine if the received occupancy state data falls below a preset expectable minimum level of an availability of free parking spaces, and upon falling below the preset minimum level, set the amount of data of the second preset range of values as the amount of data. In other words, although the driver already has local knowledge at the navigation destination, the parking assistance device can set a higher amount of data than usual if the parking assistance device determines that for example unusually few parking spaces are free on the morning of a drive.

In a further development, which can optionally be combined with the first development, the parking assistance device, if the navigation destination satisfies the preset favoring criterion, can predicate a period of time for the parking space search in the preset perimeter. If the predicated period of time exceeds a preset threshold value, the parking assistance device can set the amount of data of the second preset range of values as the amount of data. In other words, the parking assistance device can indicate more information than usual if it can be foreseen that the user would have to search very long with the usual few information. This too is a particularly good adaptation of the parking assistance method specific to situation.

In a further example of the method according to the invention, the parking assistance device can additionally receive driver behavior data, which describes a driver-specific preference with respect to a parking space location within the preset perimeter and/or a driver-specific local knowledge. In other words, the parking assistance device can determine how often the driver is at this navigation destination. For example, the driver behavior data can be determined on an electronic logbook, thus based on past drives. Then, the parking assistance device can set a data content of the provided parking space data based on the driver-specific preference. Thus, if it is known from the exemplary electronic logbook that the driver likes to park his motor vehicle in the Müller street on working days during the day although more parking spaces are usually free in the Backer street, the parking space data can correspondingly provide an indication to the parking situation in the Müller street. This is a particularly helpful driver-specific adaptation of the parking assistance method.

In order to even more efficiently configure the parking space search, an example of the parking assistance method according to the invention can provide that the parking assistance device predetermines the information content for the parking space data depending on a data quality of the occupancy state data. The inclusion of the data quality presents a level of quality to a reliability of the information about a free parking space. For example, the data quality can overall result from a number of sources external to motor vehicle, from an amount of occupancy state data of different data sources external to motor vehicle, which describes the same free parking space (thus, in other words, from the fact that many motor vehicles for example report a free parking space at the Müller street 27) and/or from a time specification, thus, this means a timeliness of the occupancy state data.

For example, the parking assistance device can ascertain the data quality of the occupancy state data depending on a number of data sources external to motor vehicle, from which the parking assistance device receives occupancy state data, and/or depending on how significant the information to a free parking space is. In other words, the data quality describes how certain the system is that the parking space is free.

Additionally or alternatively, the parking assistance device can ascertain the data quality of the occupancy state data depending on a timeliness of the received occupancy state data. In other words, the data quality can here depend on how long it has been since the free parking space has been captured and/or reported.

For example, the parking assistance device “learns” by artificial intelligence, in particular with respect to the preferences of the user and/or with respect to the reliability of the data source external to motor vehicle, and/or patterns in the availability of free parking spaces at the navigation destination.

The parking assistance device can comprise a data processing device or a processor device (or a processor), which is configured to perform an embodiment of the method according to an example of the invention. Hereto, the processor device can comprise at least one microprocessor and/or at least one microcontroller and/or at least one FPGA (Field Programmable Gate Array) and/or at least one DSP (Digital Signal Processor). Furthermore, the processor device can comprise a program code, which is configured, upon execution by the processor device, to perform the embodiment of the method according to an example of the invention. The program code can be stored in a data memory of the processor device. The parking assistance device can be configured as a control device, control chip, computer, control unit or application program (“app”).

Aspects of the invention include a storage medium with a program code, which is configured, upon execution by a processor device, such as a processor device of a mobile terminal, to cause the parking assistance device to perform an example of the above described method. For example, the storage medium can be configured as a non-transitory computer readable storage medium such as a memory card or memory chip or other data memory. A processor device may include an apparatus or an apparatus component for electronic data processing, for example. For example, the processor device can comprise at least one microcontroller and/or at least one microprocessor.

An aspect of the invention includes a mobile, portable terminal (or mobile terminal), for example a smartphone or a laptop or a tablet PC, with an embodiment of the storage medium according to the invention and/or with an embodiment of the parking assistance device according to the invention.

An aspect of the invention includes a server device for operating in the Internet, for example a data server, a backend and/or a data cloud, wherein the server device comprises an embodiment of the storage medium according to the invention and/or an embodiment of the parking assistance device according to the invention.

An aspect of the invention includes a motor vehicle, which comprises an embodiment of the parking assistance device according to the invention. For example, the motor vehicle is configured as a car, in particular as a passenger car or truck, or as a passenger bus or motorcycle.

The parking assistance device, the storage medium, the mobile, portable terminal and the motor vehicle, which comprise features as they have already been described in context of the developments of the method, also include examples of the invention. For this reason, the corresponding developments of the parking assistance device, of the storage medium, of the mobile, portable terminal and of the motor vehicle are not again described here.

A computer program or a computer program product including commands, which, upon execution of the program by a computer, cause it to execute the method of an example of the method according to the invention, are also aspects of the invention.

A computer-readable data carrier, or computer-readable medium, on which the computer program is stored, is also an aspect of the invention.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is an example of an embodiment of the method and of the devices according to the invention,

FIG. 2 is an example of an embodiment of a mobile, portable terminal according to the invention, and

FIG. 3 is an example of an embodiment of a server device according to the invention.

### DETAILED DESCRIPTION

Reference will now be made in detail to the preferred embodiments, examples of which are illustrated in the accompanying drawings, wherein like reference numerals refer to like elements throughout.

In the explained in the following, the described components each represent individual features of the invention to be considered independently of each other, which also each develop the invention independently of each other and thereby are also to be considered as a constituent of the invention in individual manner or in a combination different from the shown one. Furthermore, the described embodiments can also be supplemented by further ones of the already described features of the invention.

In the figures, functionally identical elements are each provided with the same reference characters.

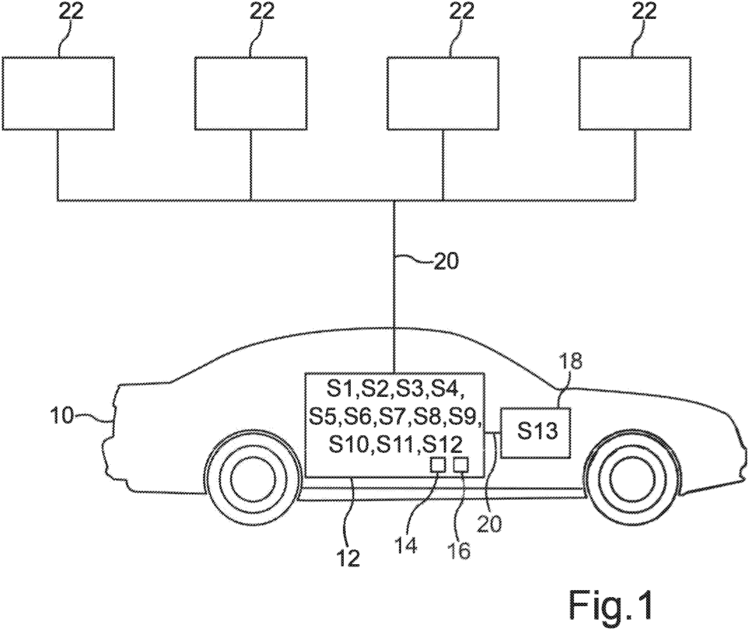

FIG. 1 illustrates the principle of the device according to the invention and of the method according to the invention based on a first example. Hereto, FIG. 1 shows a motor vehicle 10, for example a car, the driver of which is for example on his morning drive to his worksite.

The motor vehicle 10 comprises a parking assistance device 12, which can for example be a component of an on-board computer of the motor vehicle 10. The parking assistance device 12 can for example include a navigation software, communicate with a navigation device (not shown in FIG. 1) or be part of the navigation device. For example, the parking assistance device 12 can comprise a processor device 14 and/or a data memory 16.

In the example of FIG. 1, an output device 18 is additionally shown, which can for example be configured as a display device, for example instrument cluster or center display. Such an output device 18 includes a screen. For example, the output device 18 can additionally include a loudspeaker. The communication with the parking assistance device 12 is effected via a data communication link 20, for example a data bus of the motor vehicle 10 in a wired configuration, or for example via a WLAN link or Bluetooth LE link in the configuration as a wireless data communication link 20.

The communication of the parking assistance device 12 with exemplarily multiple data sources 22 external to motor vehicle can be effected via mobile radio and/or Internet links. Therein, the data sources 22 external to motor vehicle can be communication units of other motor vehicles, which are already at the navigation destination of the motor vehicle 10. Alternatively, one or more of the data sources 22 external to motor vehicle can for example be data servers in the Internet, which provide information to free parking spaces for example from parking lot surveillance systems.

The parking assistance device 12 can for example determine (S1) the navigation destination of the drive in that the parking assistance device 12 performs a corresponding query at the navigation device. The navigation destination of the example of FIG. 1 can for example be stored in the navigation device as “home” or as another favored navigation destination. Additionally or alternatively, historic data from a user profile of the driver can for example show that the driver usually drives to this navigation destination from Monday morning to Friday morning, thus that the determined navigation destination is his worksite.

The parking assistance device 12 receives occupancy state data from the data sources 22 external to motor vehicle (S2).

In the example of FIG. 1, this exemplary number of data sources 22 external to motor vehicle can optionally serve as a basis for that the parking assistance device 12 can ascertain (S3) that this is a number which can for example associate a mean value to a data quality. In addition, the parking assistance device 12 can optionally ascertain (S3) that three of the four exemplary data sources 22 external to motor vehicle for example report two free parking spaces in the Müller street 22, which is located in the vicinity of the employer, at the current point of time. The data quality determined by the parking assistance device 12 can thereby obtain a higher value. In the example of FIG. 1, the information can also give a high significance of the information about the two free parking spaces in the Müller street.

In other words, the occupancy state data to the information “two free parking spaces at the Müller street 22” can have a high level of quality. A further aspect for the significance of the two free parking spaces in the Müller street 22 can for example be that the parking assistance device 12 recognizes for example based on the user profile, for example on historic data, that the driver preferably parks in the Müller street.

In other words, the parking assistance device 12 has ascertained (S4) the Müller street or the Müller street 22 as a location of two free parking spaces.

It was already above addressed that the navigation destination is prospectively the worksite of the driver such that it is determined in the examination S5 that the preset favoring criterion is satisfied with a very high probability. In S6, the parking assistance device 12 now determines the information content for the parking space data to be generated and to be output.

In the example of FIG. 1, thus, a low amount of data can be set (S7) since the driver obviously has good local knowledge. In case of the example of FIG. 1, it is for example a commuter, who presumably already knows where he finds a good parking space. Thus, only few information to the driver are first really helpful. Since the driver also already knows where the Müller street is, a navigation aid either does not have to be provided to him. However, if the parking assistance device 12 determines that the parking situation is unexpectedly particularly poor and/or different than usual today on this day, after such an examination S8 to the effect if it is fallen below a preset expectable minimum level of availability of free parking spaces, the parking assistance device 12 can cause the amount of data for the parking space data to be nevertheless again increased (S7). Such a correction S7 to a higher amount of data can also be effected if the parking assistance device 12 predicates (S9) that today the driver will take substantially longer for the parking space search than usual. In this case, the navigation instructions can be reasonable after all.

The driver-specific local knowledge can optionally be described by driver behavior data or be derived from it, which the parking assistance device 12 can optionally receive from for example a query of the user profile (S10).

In S11, the parking assistance device 12 provides the parking space data, for example generates it, wherein it can describe the Müller street, the predetermined amount of data and the content of the information to the parking space. The parking assistance device 12 then transfers the parking space data to the output device 18 (S12), and the output device 18 outputs the information in S13.

In another example, the data content can be individually adapted if something is exceptionally free a little closer to the office of the driver on this day. If there are exceptionally especially many free parking spaces around the worksite of the driver on this morning, for example because the school holidays have begun and many colleagues are on vacation, a proposal to the parking space situation can be completely unimportant and the output S13 can be omitted.

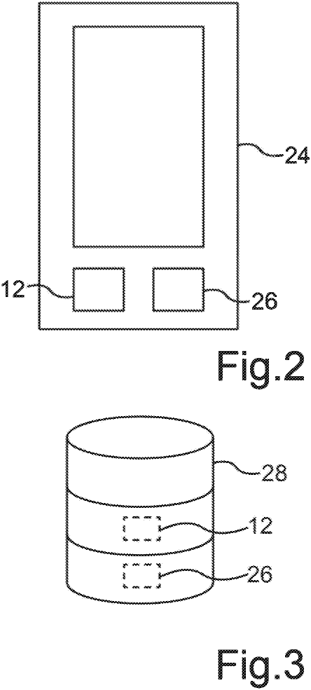

FIG. 2 shows an exemplary mobile terminal 24, which can for example be configured as a mobile phone in the example of FIG. 3. Therein, the parking assistance device 12 can correspond to mobile terminal 24 as the parking assistance device 12 was explained in detail in FIG. 1.

FIG. 3 shows an exemplary server device 28, for example a data server, which can include a configuration of the parking assistance device 12, and/or a storage medium 26, for example a hard disk or a memory chip. If the exemplary data server includes a storage medium 26, thus, it can comprise a program code for performing the method.

Overall, the examples illustrate how parking recommendations can be allowed depending on the assistance demand and data quality.

In a further example, a system maximizes the utility of proactive parking space proposals. It considers the data quality, data content and/or driver behavior to determine if and which type of information is most helpful in a certain situation and at a certain location.

Real-time parking space availability data is never 100 percent accurate; in reality, it is far away from it. The reliability of the data can be incorporated in a content provider (statistic safety), and/or can be derived from a fleet data analysis if multiple drivers in the region, who follow the proposals, do not park in the proposed positions, but continue their search.

If the data accuracy is high or low, is to determine if, when and how much information is presented in the notifications with the proposals. Exemplarily, it can be provided:

### 1. High Accuracy

Drivers, who travel to navigation destinations, which are rather unknown to them, need the most assistance. The proposal of each closest available free parking space it mostly useful, but a notification is useless if free parking spaces are not available in the vicinity at all or it is known that all of the parking spaces are occupied.

In addition, a proposal of a specific parking space is unnecessary if there is a plurality of available parking space options directly at the destination address. Then, a notification that the entire region is free or occupied or neither, is sufficient. Thereto, an active navigation is ideally advantageous.

Commuters, who travel to the same destination address almost every day, very well know the parking space availability situation and know, which parking spaces one first examines. A notification is only helpful if:
a) the parking situation unexpectedly deviates from that on other days, thus if usually occupied parking spaces are for example surprisingly available today, or usually free parking spaces are temporarily closed due to construction works.
b) A parking space search duration, which is longer than usual, is detected. The driver can very likely need more proposals since his own knowledge of the situation for example has obviously failed. So-called “less attractive” parking spaces, for example ones with longer walking time to the navigation destination or a more expensive public garage, and in particular information to a recently released parking space can now be very helpful. For example, a predictive navigation function can be active; a running navigation is not required.

### 2. Low Accuracy

With a possible medium to low data accuracy, the driver should not be intrusively notified with proposals to parking spaces, which are then nevertheless occupied. At most, a trend of the region (for example like rather empty or rather full) can be derived. For example, only this trend can be proactively presented to “foreign” drivers and not to commuters. Commuters presumably know the situation better than data with low quality could.

The utility of parking notifications depends on the data coverage in the region, the availability of free parking spaces, the data quality and the experience and the knowledge of the driver. Every day, commuters need different parking information at different times. The information can be less obtrusively presented if the driver already very well knows his drive destination. It is allowed to present an individual middle course between too much and no information. The information content and the timing of a pop-up can be adapted to the respective situation. Thereby, an increased driving safety by less distraction also arises. An increased acceptance of the users and an increased comfort also arise since the proposed system results in less unnecessary and unhelpful notifications. The optimized parking search results in less traffic in cities and less infringement by parking violation.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

List of reference characters

| | |
|---|---|
| 10 | Motor vehicle |
| 12 | parking assistance device |
| 14 | processor device |
| 16 | data memory |
| 18 | output device |
| 20 | data communication link |
| 22 | data source external to motor vehicle |
| 24 | mobile, portable terminal |
| 26 | storage medium |
| 28 | server device |
| S1 - S13 | method operations |

What is claimed is:

1. A parking assistance method for a drive with a motor vehicle, comprising:
by a parking assistance device:
determining a navigation destination of the drive of the motor vehicle;
receiving occupancy state data from at least one data source external to the motor vehicle, wherein the occupancy state data includes information of an availability of free parking spaces for a preset perimeter around the navigation destination;
ascertaining at least one location of a free parking space based on the received occupancy state data;
examining whether the navigation destination satisfies a preset favoring criterion, which presets a minimum probability of a driver-specific favoring and/or frequency, with which a driver of the motor vehicle drives to the navigation destination;
in response to whether the navigation destination satisfies the preset favoring criterion, predetermining an information content for parking space data for the drive;
providing parking space data with the predetermined information content, which describes a proposal to the ascertained location of the free parking space related to the navigation destination; and
transferring the provided parking space data to an output device to output the provided parking space data.

2. The parking assistance method according to claim 1, wherein the predetermined information content presets a data content and/or an amount of data of the parking space data.

3. The parking assistance method according to claim 1, wherein by the parking assistance device:
when the navigation destination satisfies the preset favoring criterion, setting an amount of data in a first preset range of values as the information content; and/or, when the navigation destination does not satisfy the preset favoring criterion, setting an amount of data in a second preset range of values as the amount of data, which sets a higher amount of data compared to the first preset range of values.

4. The parking assistance method according to claim 2, wherein by the parking assistance device:
when the navigation destination satisfies the preset favoring criterion, setting an amount of data in a first preset range of values as the information content; and/or, when the navigation destination does not satisfy the preset favoring criterion, setting an amount of data in a second preset range of values as the amount of data, which sets a higher amount of data compared to the first preset range of values.

5. The parking assistance method according to claim 3, wherein by the parking assistance device, when the navigation destination satisfies the preset favoring criterion:
examining whether the received occupancy state data falls below a preset expectable minimum level of an availability of free parking spaces, and
upon falling below the preset minimum level, setting the amount of data of the second preset range of values as the amount of data.

6. The parking assistance method according to claim 4, wherein by the parking assistance device, when the navigation destination satisfies the preset favoring criterion:
examining whether the received occupancy state data falls below a preset expectable minimum level of an availability of free parking spaces, and
upon falling below the preset minimum level, setting the amount of data of the second preset range of values as the amount of data.

7. The parking assistance method according to claim 3, wherein by the parking assistance device, when the navigation destination satisfies the preset favoring criterion:
predicating a period of time for the parking space search in the preset perimeter, and
when the predicated period of time exceeds a preset threshold value, setting the amount of data of the second preset range of values as the amount of data.

8. The parking assistance method according to claim 4, wherein by the parking assistance device, when the navigation destination satisfies the preset favoring criterion:
predicating a period of time for the parking space search in the preset perimeter, and
when the predicated period of time exceeds a preset threshold value, setting the amount of data of the second preset range of values as the amount of data.

9. The parking assistance method according to claim 5, wherein by the parking assistance device, when the navigation destination satisfies the preset favoring criterion:
predicating a period of time for the parking space search in the preset perimeter, and
when the predicated period of time exceeds a preset threshold value, setting the amount of data of the second preset range of values as the amount of data.

10. The parking assistance method according to claim 6, wherein by the parking assistance device, when the navigation destination satisfies the preset favoring criterion:
predicating a period of time for the parking space search in the preset perimeter, and when the predicated period of time exceeds a preset threshold value, setting the amount of data of the second preset range of values as the amount of data.

11. The parking assistance method according to claim 1, wherein by the parking assistance device:
receiving driver behavior data, which describes a driver-specific preference with respect to a parking space location within the preset perimeter and/or a driver-specific local knowledge, and
setting a data content of the provided parking space data based on the driver-specific preference.

12. The parking assistance method according to claim 2, wherein by the parking assistance device:
receiving driver behavior data, which describes a driver-specific preference with respect to a parking space location within the preset perimeter and/or a driver-specific local knowledge, and
setting a data content of the provided parking space data based on the driver-specific preference.

13. The parking assistance method according to claim 1, wherein by the parking assistance device,
predetermining the information content for the parking space data depending on a data quality of the occupancy state data, comprising ascertaining the data quality of the occupancy state data depending on:
a number of data sources external to the motor vehicle, from which the parking assistance device receives occupancy state data, and/or how significant the information to a free parking space is; and/or
a timeliness of the received occupancy state data.

14. A parking assistance device which is configured to perform a method according to claim 1.

15. A non-transitory computer-readable storage medium storing instructions which, upon execution by a parking assistance device comprising a processor device, cause the parking assistance device to execute a method according to claim 1.

16. A mobile terminal comprising:
a processor; and
a non-transitory computer-readable storage medium storing instructions which, upon execution by the processor, cause the mobile terminal to execute operations comprising:
determining a navigation destination of a drive of a motor vehicle;
receiving occupancy state data from at least one data source external to the motor vehicle, wherein the occupancy state data includes information of an availability of free parking spaces for a preset perimeter around the navigation destination;
ascertaining at least one location of a free parking space based on the received occupancy state data;
examining whether the navigation destination satisfies a preset favoring criterion, which presets a minimum probability of a driver-specific favoring and/or frequency, with which a driver of the motor vehicle drives to the navigation destination;
in response to whether the navigation destination satisfies the preset favoring criterion, predetermining an information content for parking space data for the drive;
providing parking space data with the predetermined information content, which describes a proposal to the ascertained location of the free parking space related to the navigation destination; and
transferring the provided parking space data to an output device to output the provided parking space data.

17. The mobile terminal according to claim 16 further comprising a parking assistance device comprising the processor and the non-transitory computer-readable medium.

18. A server device operating in the Internet and comprising the non-transitory computer-readable storage medium according to claim 15.

19. A server device operating in the Internet and comprising a parking assistance device according to claim 14.

20. A motor vehicle comprising:
a parking assistance device comprising:
a processor; and
a non-transitory computer-readable storage medium storing instructions which, upon execution by the processor, cause the parking assistance device to execute operations comprising:
determining a navigation destination of a drive of a motor vehicle;
receiving occupancy state data from at least one data source external to the motor vehicle, wherein the occupancy state data includes information of an availability of free parking spaces for a preset perimeter around the navigation destination;
ascertaining at least one location of a free parking space based on the received occupancy state data;
examining whether the navigation destination satisfies a preset favoring criterion, which presets a minimum probability of a driver-specific favoring and/or frequency, with which a driver of the motor vehicle drives to the navigation destination;
in response to whether the navigation destination satisfies the preset favoring criterion, predetermining an information content for parking space data for the drive;
providing parking space data with the predetermined information content, which describes a proposal to the ascertained location of the free parking space related to the navigation destination; and
transferring the provided parking space data to an output device to output the provided parking space data.
